(19) United States
(12) Patent Application Publication
(10) Pub. No.: US 2013/0176188 A1
(43) Pub. Date: Jul. 11, 2013

(54) COMPACT HIGH-GAIN ANTENNA

(71) Applicant: Eduardo Motta Cruz, Saint Herblain (FR)

(72) Inventor: Eduardo Motta Cruz, Saint Herblain (FR)

(73) Assignee: BOUYGUES TELECOM, Paris (FR)

(21) Appl. No.: 13/824,230

(22) PCT Filed: Sep. 29, 2011
(86) PCT No.: PCT/EP2011/067026

§ 371 Date: Mar. 15, 2013

(30) Foreign Application Priority Data
Sep. 29, 2010 (FR) 1057864

(51) Int. Cl. H01Q 1/38

(52) U.S. Cl. CPC H01Q 1/38
USPC 343/844

(57) ABSTRACT

The invention relates to a panel antenna comprising: a ground plane (P); a dielectric substrate (11) having a permittivity (ε₁), the substrate (11) being located on the ground plane (P); at least one radiating source (Sᵢ), each radiating source consisting of a plurality of antenna elements (Eᵢⱼ), the antenna elements (Eᵢⱼ) being located on the substrate (11) and furthermore consecutively spaced apart, relative to one another, by a distance (dₑ) shorter than one wavelength λ, the wavelength λ corresponding to the antenna operating frequency. The antenna is characterized in that it furthermore comprises a dielectric superstrate (12) having a permittivity (ε₂) higher than the permittivity (ε₁) of the substrate (11), the superstrate being located above the antenna elements (Eᵢⱼ), and in that the antenna elements (Eᵢⱼ) are all identical and have, in operation, identical radiation characteristics.

### GENERAL TECHNICAL FIELD

The invention relates to the field of panel antennas, particularly those used in cellular networks.

### STATE OF THE ART

Base transceiver stations (BTS) are subject to major constraints in terms of height arrangement (church louvers, bas-reliefs of the façades of protected buildings, etc.).

Cellular networks currently resort to isotropic high-gain antennas in order to maximise their radio range. These gains are obtained by means of panels of heights commonly varying between 1.2 m for the 1800/2100 MHz band and 2.4 m for the 900 MHz band.

A panel antenna comprises in the familiar manner a plurality of antenna elements arranged in a vertical row on a substrate.

FIG. 1 illustrates a panel antenna of known type.

The panel antenna in FIG. 1 comprises eight antenna elements Eᵢ (i=1 to 8) arranged on a substrate 11; each antenna element Eᵢ comprises an access point Aᵢ and is spaced apart at a distance dₑ of approx. 0.9λ, wherein λ is the vacuum wavelength at the central frequency of the frequency band of the antenna. The distance is understood between two access points Aᵢ of the antenna elements Eᵢ.

The antenna elements Eᵢ are supplied in a tree structure for example: the adjacent antenna elements Eᵢ are connected two by two by means of a first supply line L₁ in order to form four pairs of antenna elements.

The pairs are furthermore connected two by two by means of a second supply line L₂ in order to form two quadruplets of antenna elements and the quadruplets are finally interconnected by means of a third supply line L₃.

It is observed that the supply lines are defined between two access points Aᵢ of each antenna element Eᵢ.

FIGS. 2a and 2b respectively illustrate a top view and a side view of an antenna element Eᵢ arranged on a substrate 11. The antenna element Eᵢ arranged on the substrate forms a radiating source termed a “patch”.

The dielectric substrate 11 has a dielectric constant ε₁ and is arranged on a ground plane P, wherein the antenna element Eᵢ is arranged on the substrate 11.

The antenna element Eᵢ is arranged on the dielectric substrate 11 connected to a connector Aᵢ in order to supply the antenna element Eᵢ.

Each antenna element Eᵢ displays during operation a unit gain of approx. 8 dBi; the antenna in FIG. 1 therefore displays a gain of 8 dBi+10 log(8)=17 dBi for a height of 8×0.9λ=7.2λ.

The tables in FIGS. 3a and 3b show the ratio between the gain of the antenna and its height for two main frequency bands used in cellular networks (the 880-960 MHz band, known as “900 MHz” and the 1710-2170 MHz band, known as “2100 MHz”) at the central frequency of the antenna frequency band. It is noticed in particular that in order to progress from a gain of 15 dBi to 17 dBi, the antenna height needs to be approximately doubled for a given central frequency.

It can therefore be seen that the height of the antenna is dictated by the number of antenna elements Eᵢ. Hence, the greater the gain of the antenna, the more elements are required and the larger the size of the antenna.

This is not unproblematic, since the current trend involves imposing maximum heights for panel antennas or indeed reductions in height.

A solution is known for reducing the size of a panel antenna, involving eliminating some antenna elements Eᵢ. Such elimination however results in a loss in terms of antenna gain and therefore deterioration in the antenna performances.

### PRESENTATION OF THE INVENTION

One aim of the invention is to enable an increase in the gain of an antenna without having to increase the size of the antenna.

Another aim of the invention is to enable a reduction in the height of an antenna without any decrease in the gain of the antenna.

Hence, the invention relates to a panel antenna comprising a ground plane, a dielectric substrate, having a permittivity, wherein the substrate is arranged on the ground plane, at least one radiating source, wherein each radiating source is formed of a plurality of antenna elements, wherein the antenna elements are arranged on the substrate and are furthermore consecutively spaced apart in relation to one another at a distance of less than a wavelength λ, said wavelength λ corresponding to the antenna operating frequency.

The antenna according to the invention is characterised in that it furthermore comprises a dielectric superstrate, having a permittivity greater than the permittivity of the substrate, wherein the superstrate is arranged above the antenna elements and the antenna elements are all identical and possess during operation identical radiating characteristics.

The arrangement of the antenna elements forming each radiating source makes it possible to achieve a reduction in height with constant gain or obtain an increase in the gain with constant height.

Preferably, the antenna furthermore comprises a dielectric superstrate, having a permittivity greater than the permittivity of the substrate, wherein the superstrate is arranged on the antenna elements.

The combination of the superstrate with the arrangement of the antenna elements makes it possible to achieve either the reduction in height with constant gain or an increase in the gain with constant height.

The invention is advantageously supplemented by the following characteristics, considered alone or in any of their technically feasible combinations:
each radiating source comprises four antenna elements connected successively in pairs by the means of a first supply line, wherein said pairs are connected to each other by means of a second supply line, wherein the centre of the second supply line comprises an access point of the radiating source adapted for supply of said radiating source;
it comprises several radiating sources, wherein the radiating sources are arranged in relation to each other such that their access points are spaced apart by a distance equal to the distance between two antenna elements, wherein each radiating source possesses identical radiating characteristics;
the antenna elements are arranged in relation to one another with a distance dₑ equal to dₛ(N−1)/N, wherein dₛ is the distance between two access points of two radiating sources and N is the number of antenna elements of each radiating source;
each radiating source preferentially comprises between two and six antenna elements;
the antenna elements are patches having a shape selected from among the following group: square, equilateral triangle, elliptical;
the antenna elements are derived from the following technologies: horns or wire antennas;
it comprises a resistance connected between the ground plane and each antenna element.

The invention also relates to a cellular communication network comprising a panel antenna according to the invention.

### PRESENTATION OF THE FIGURES

Other characteristics and advantages of the invention will furthermore become apparent from the following description, which is merely illustrative and non-limitative and must be read with reference to the appended drawings on which, apart from FIGS. 1, 2a, 2b, 3a and 3b already discussed:

FIG. 4 illustrates a panel antenna according to a first embodiment of the invention;

FIG. 5 illustrates a panel antenna according to a second embodiment of the invention;

FIGS. 6a and 6b respectively illustrate a top view and a side view of an antenna element of the antenna according to the invention;

FIG. 7 illustrates and elemental source according to the invention;

FIG. 8 illustrates a panel antenna of known type displaying during operation the same gain as the antenna according to the first embodiment of the invention;

FIG. 9 illustrates a panel antenna of known type having the same height as the antenna according to the second embodiment of the invention.

In all the figures, similar elements bear identical numerical references.

### DETAILED DESCRIPTION OF THE INVENTION

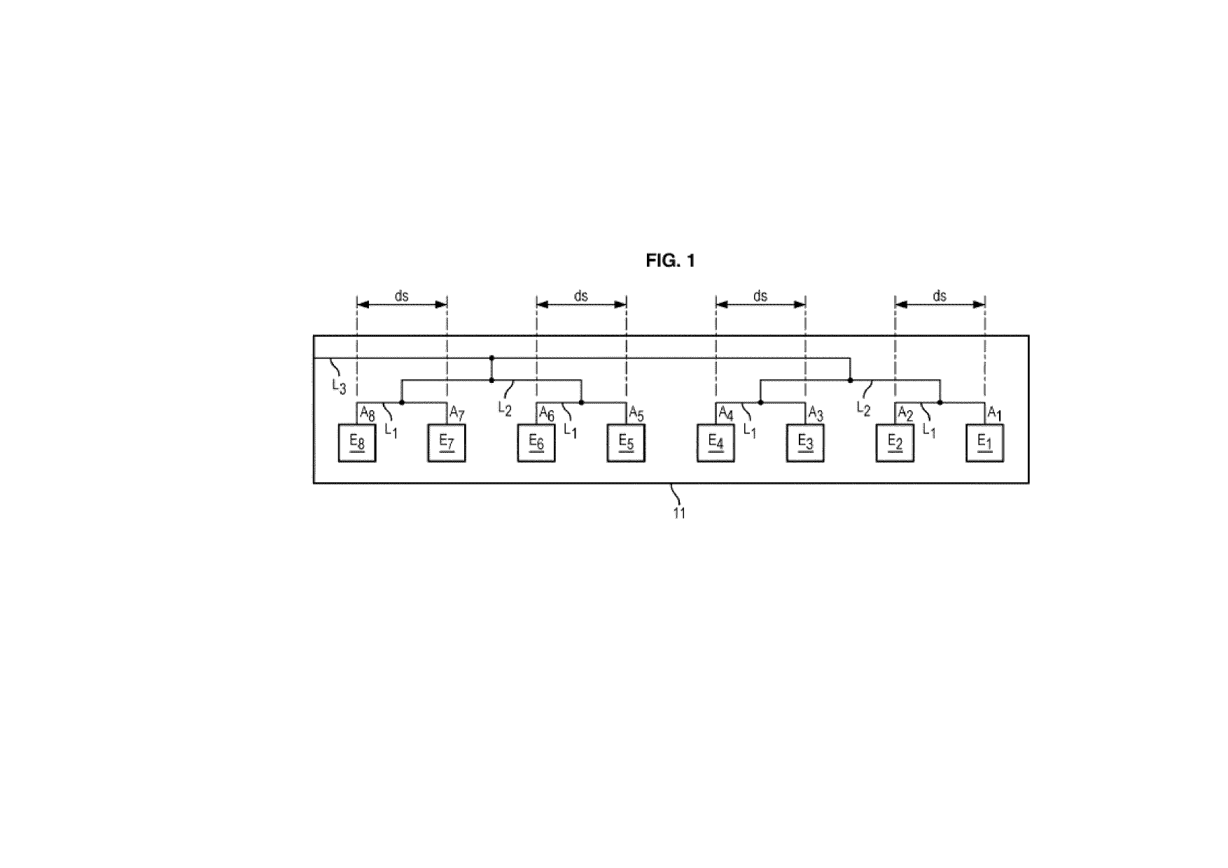

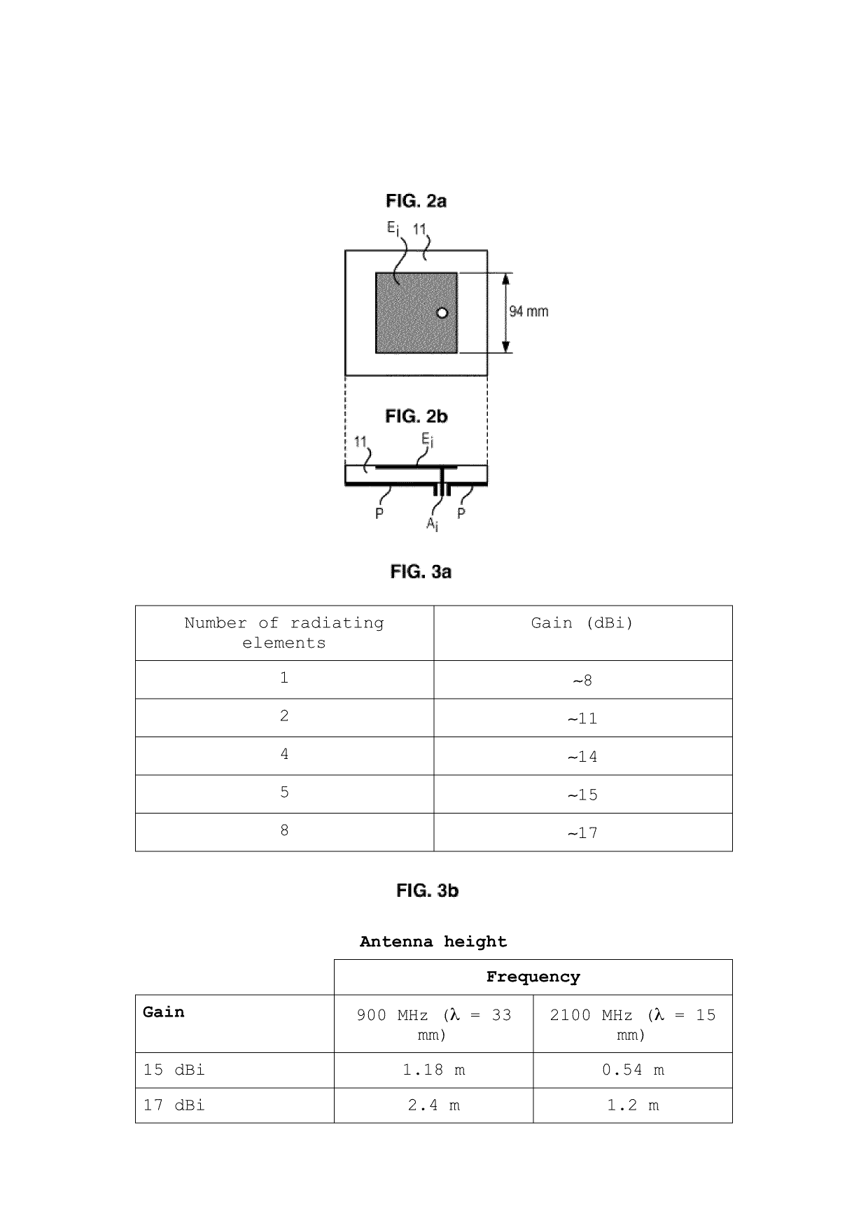

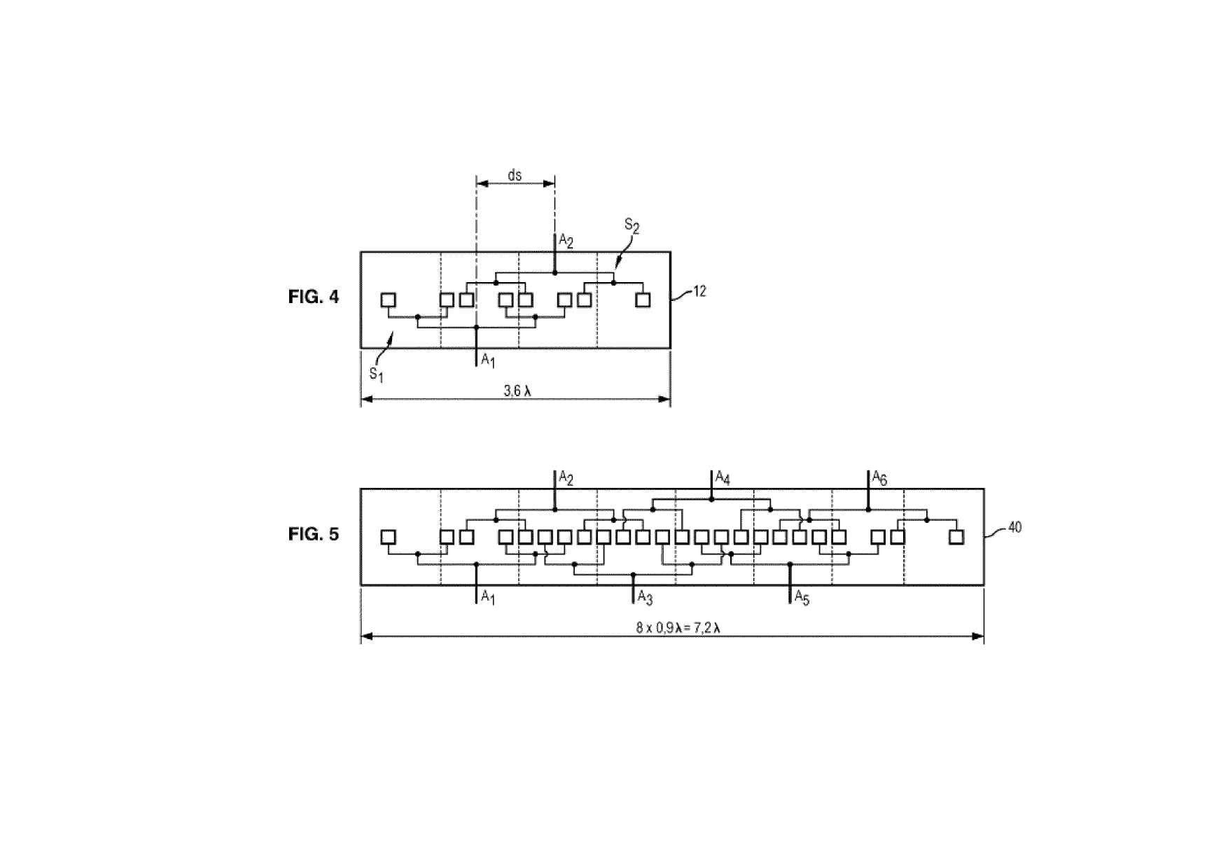

Two embodiments of the invention are described below in relation to FIGS. 4 to 9.

“Antenna element” is taken to mean a radiating element having a preferably flat conducting body.

“Radiating source” is taken to mean the combination of several antenna elements.

“Panel antenna” is taken to mean a planar antenna comprising several antenna elements.

For each embodiment, the panel antenna comprises a dielectric substrate 11 having a permittivity ε₁, wherein the substrate 11 is arranged on a ground plan P. Furthermore, the panel antenna comprises at least one radiating source Sᵢ.

Each radiating source Sᵢ is formed of a plurality of antenna elements Eᵢⱼ consecutively spaced apart in relation to one another. Two consecutive antenna elements are spaced apart by a distance dₑ less than the wavelength λ, said wavelength λ corresponding to the antenna operating frequency.

The antenna in FIG. 4 comprises two radiating sources S₁, S₂ and the antenna in FIG. 5 comprises six radiating sources.

Advantageously, each radiating source Sᵢ comprises four antenna elements Eᵢ₁, Eᵢ₂, Eᵢ₃, Eᵢ₄ connected in pairs in a tree structure for example by means of a first supply line L₁.

Each antenna element comprises an access point Aᵢⱼ for connection of the antenna elements in pairs by means of the supply line L₁.

The pairs of antenna elements Eᵢⱼ are connected by means of a second supply line L₂. The centre of the second supply line L₂ comprises an access point Aᵢ of the radiating source Sᵢ. Such an access point Aᵢ is adapted for supply of the radiating source Sᵢ to which it refers.

As can be seen, there are as many access points Aᵢ as there are radiating sources Sᵢ. Hence, the antenna in FIG. 5 comprising six radiating sources therefore comprises six access points A₁, A₂, A₃, A₄, A₅, A₆.

The radiating sources Sᵢ are arranged in relation to each other such that their access points Aᵢ are spaced apart by a distance equal to the distance dₛ between two consecutive access points of two radiating sources Sᵢ.

Furthermore, the antenna elements Eᵢⱼ of a radiating source Sᵢ are arranged in relation to one another with a distance dₑ equal to dₛ(N−1)/N, wherein dₛ is the distance between the radiating sources Sᵢ and N is the number of antenna elements Eᵢⱼ of each radiating source Sᵢ. The distance dₑ is in turn the distance between two consecutive access points Aᵢⱼ of each antenna element Eᵢⱼ.

To be more precise, in defining a main axis passing through the centres of symmetry of each antenna element, the access points Aᵢⱼ of each antenna element are located on an axis perpendicular to the main axis, the first and second supply lines L₁, L₂ being parallel to the main axis.

Preferably, each radiating source Sᵢ comprises four radiating elements Eᵢⱼ.

The antenna furthermore comprises (those of FIGS. 4 and 5) a dielectric superstrate 12 having a permittivity ε₂ greater than the permittivity ε₁ of the substrate 11 which is arranged on the antenna elements Eᵢⱼ.

In relation to an antenna element Eᵢ forming a radiating source of the patch type, of known type, the antenna element Eᵢⱼ is thus immersed in a medium with high permittivity, which allows a reduction in the size of the antenna element in order to reduce its operating wavelength, or rather retain it and reduce its physical dimensions.

Use of the substrate 12 makes it possible to retain radiating characteristics identical to those of an antenna element of greater height.

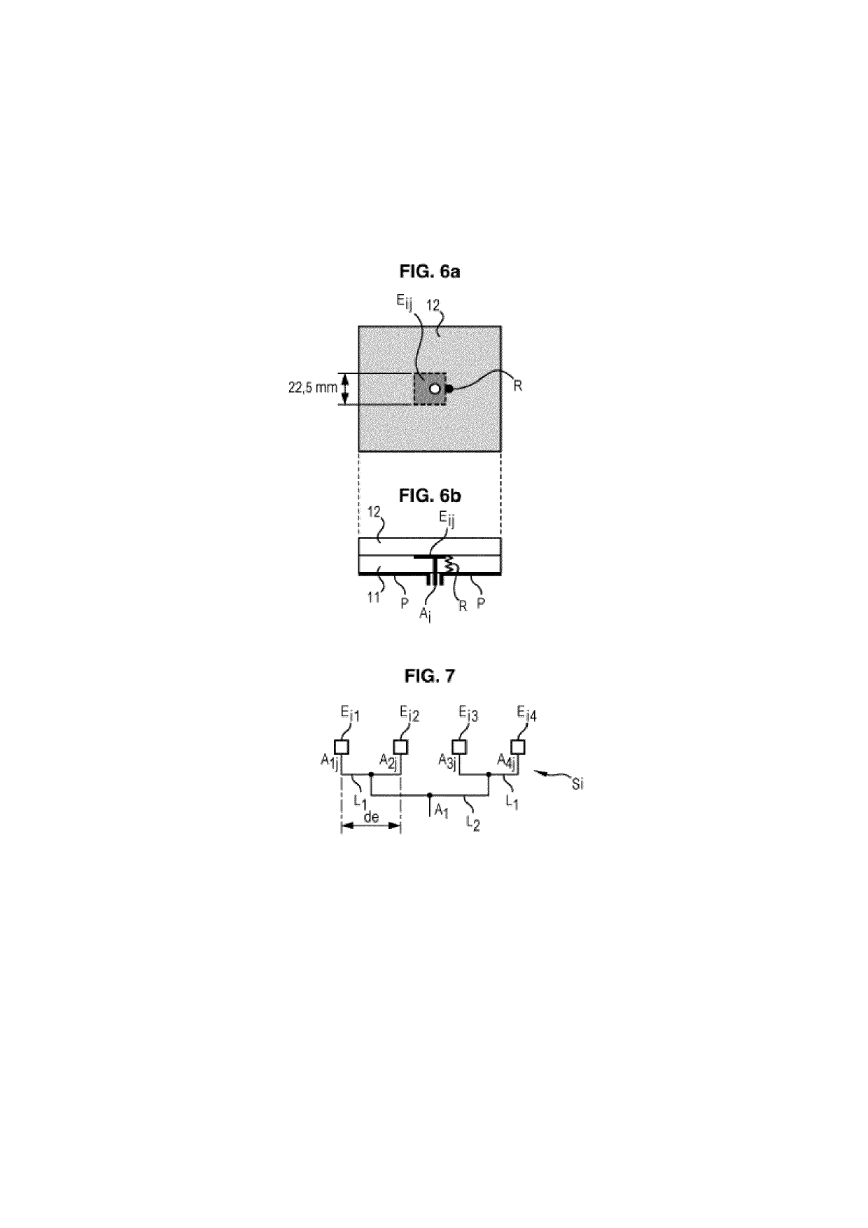

Furthermore, a resistance R is connected between the ground plane P and each antenna element Eᵢⱼ (refer to FIGS. 6a and 6b). The resistance R is typically equal to one Ohm. This resistance R serves to short circuit one of the radiating sides of the antenna element. This short circuit serves to transform the radiating element of size λ/2, formed of two monopoles, each of size λ/4 on each side of the dipole, into a single monopole of size λ/4 and consequently makes it possible to halve the electrical dimensions of the radiating element.

This resistance R also allows an appreciable increase in the passband of the antenna in its resonant behaviour.

Finally, the permittivity ε₁ is for example between 1 and 4 and is preferably equal to 2.2 and the permittivity ε₂ is for example between 10 and 50 and is preferably equal to 30.

By way of example, in relation to the antenna element Eᵢ of a patch of known type, for an operating frequency in the GSM band at a central frequency of 920 MHz, the side of the antenna element Eᵢ is of dimensions equal to 94 mm whereas the side of the antenna element Eᵢⱼ (with the superstrate) is of dimensions equal to 21.5 mm.

Still by way of example, one may consider antenna elements Eᵢⱼ which are square, in the shape of an equilateral triangle or elliptical in shape or derived from the following technologies: horns or wire antennas allowing combination of sources owing to their small size or small radiating aperture.

### Reduction In Height—Constant Gain

The antenna illustrated in FIG. 4 allows a reduction in height of a panel antenna of known type while retaining the same gain of 17 dBi.

It comprises two radiating sources S₁, S₂ spaced apart by a distance dₛ=0.9λ, each consisting of four antenna elements spaced apart by a distance dₑ=0.9λ (4−1)/4=0.675λ (refer to FIG. 7).

Each radiating source displays a gain of 14 dBi during operation such that the antenna in FIG. 4 displays a gain of 17 dBi during operation.

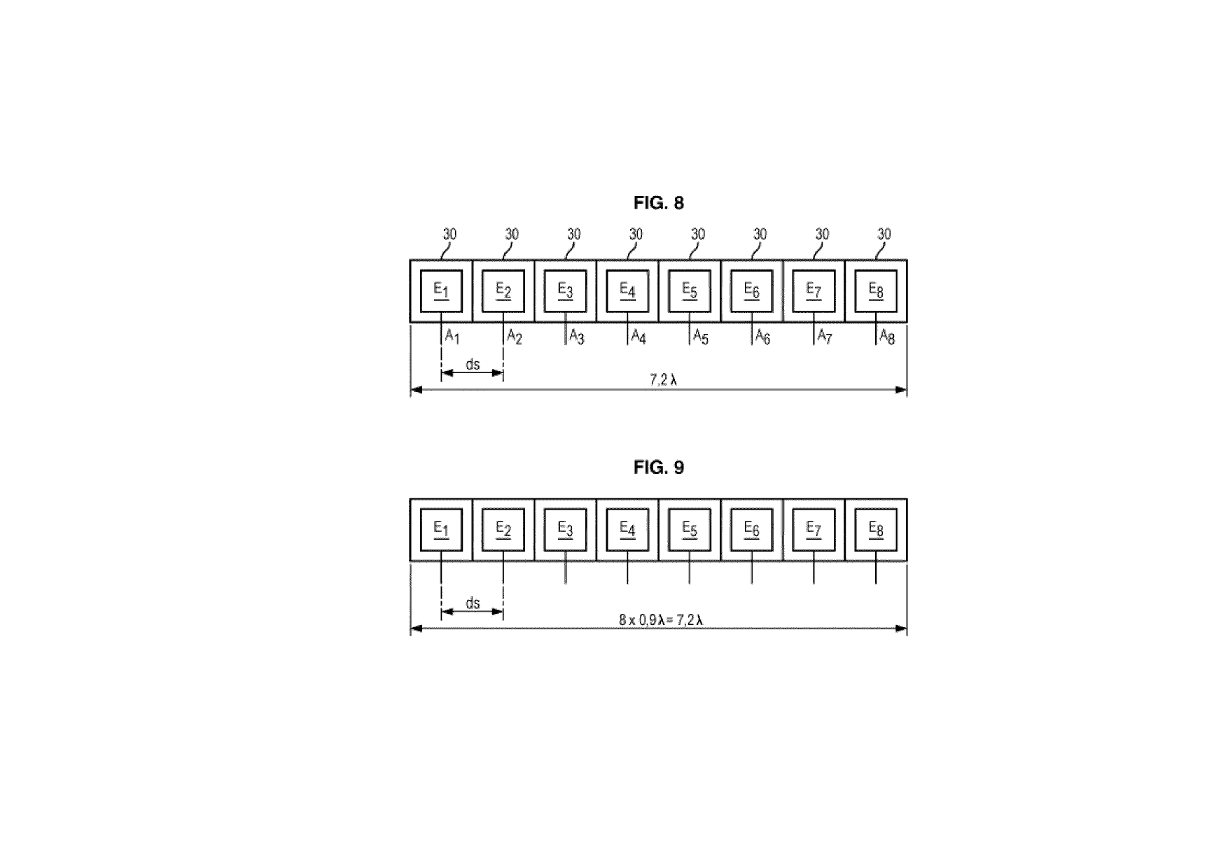

Nevertheless, in relation to the antenna as illustrated in FIG. 8, the height is halved: the reduction is from 7.2λ (8×0.9λ) to 3.6λ (4×0.9λ).

The radiating sources S₁ and S₂, each having an access point A₁, A₂, are nested along the longitudinal axis of the antenna (refer to FIG. 4) such that the points of access Aᵢ of the sources Sᵢ are set apart by the same distance dₛ. In order to facilitate understanding of the supply circuit of the different sources, each access point is arranged on a side opposite the following access point.

The distance between two consecutive radiating elements belonging to two different radiating sources varies between dₛ/N and dₛ(N−1)/N, i.e. between 0.225λ and 0.675λ.

### Increase In Gain—Constant Height

The antenna illustrated in FIG. 5 allows an increase in gain of the antenna while retaining the same height as a panel antenna of known type.

It comprises six radiating sources, each consisting of four antenna elements (refer to FIG. 7).

As in the preceding embodiment, each radiating source displays a gain of 14 dBi during operation such that the antenna in FIG. 5 displays a gain of 21.8 dBi during operation instead of 17 dBi obtained by the antenna of the same height, as illustrated in FIG. 9 (height equal to 7.2λ).

As above, the radiating sources, each having an access point A₁, A₂, A₃, A₄, A₅, A₆, are nested along the longitudinal axis of the antenna (refer to FIG. 5) such that the access points Aᵢ of the sources Sᵢ are set apart by the same distance dₛ. In order to facilitate understanding of the supply circuit of the different sources, each access point is arranged on a side opposite the following access point.

The distance between two consecutive radiating elements belonging to two different radiating sources varies between dₛ/N and dₛ(N−1)/N, i.e. between 0.225λ and 0.675λ.

1. Panel antenna comprising a ground plane (P), a dielectric substrate (11), having a permittivity (ε₁), wherein the substrate (11) is arranged on the ground plane (P), at least one radiating source (Sᵢ), wherein each radiating source is formed of several antenna elements (Eᵢⱼ), wherein the antenna elements (Eᵢⱼ) are arranged on the substrate (11) and are furthermore consecutively spaced apart in relation to one another at a distance (dₑ) of less than a wavelength λ, said wavelength λ corresponding to the antenna operating frequency; the antenna is characterised in that it furthermore comprises a dielectric superstrate (12), having a permittivity (ε₂) greater than the permittivity (ε₁) of the substrate (11), wherein the superstrate is arranged above the antenna elements (Eᵢⱼ) and the antenna elements (Eᵢⱼ) are all identical and possess during operation identical radiating characteristics.

2. Antenna according to claims 1 wherein each radiating source (Sᵢ) comprises four antenna elements (Eᵢ₁, Eᵢ₂, Eᵢ₃, Eᵢ₄) connected successively in pairs by means of a first supply line (L₁), wherein said pairs are connected to each other by means of a second supply line (L₂), the centre of the second supply line (L₂) comprises an access point (Aᵢ) of the radiating source (Sᵢ) adapted for supply of said radiating source (Sᵢ).

3. Antenna according to claim 2 comprising several radiating sources (Sᵢ), wherein the radiating sources (Sᵢ) are arranged in relation to each other such that their access points (Aᵢ) are spaced apart by a distance equal to the distance between two antenna elements (Eᵢⱼ), wherein each radiating source (Sᵢ) possesses identical radiating characteristics.

4. Antenna according to any of the above claims wherein the antenna elements (Eᵢⱼ) are arranged in relation to one another with a distance dₑ equal to dₛ(N−1)/N, wherein dₛ is the distance between two access points (Aᵢ) of two radiating sources (Sᵢ) and N is the number of antenna elements (Eᵢⱼ) of each radiating source (Sᵢ).

5. Antenna according to any of the above claims, wherein each radiating source (Sᵢ) preferentially comprises between two and six antenna elements (Eᵢⱼ).

6. Antenna according to any of the above claims wherein the antenna elements (Eᵢⱼ) are patches having a shape selected from among the following group: square, equilateral triangle, elliptical.

7. Antenna according to any of the above claims wherein the antenna elements (Eᵢⱼ) are derived from the following technologies: horns or wire antennas.

8. Antenna according to any of the above claims, comprising a resistance (R) connected between the ground plane (P) and each antenna element (Eᵢⱼ).

9. Cellular communication network comprising a panel antenna according to any of the above claims.
